(19) United States
(12) Patent Application Publication
(10) Pub. No.: US 2010/0310036 A1
(43) Pub. Date: Dec. 9, 2010

(54) COMPUTED TOMOGRAPHY METHOD AND APPARATUS

(75) Inventors: Sarah Jean Burleton, Wauwatosa, WI (US); Sandeep Dutta, Waukesha, WI (US); Bradley J. Gabrielse, Oostburg, WI (US); Sardar Gautham, Waukesha, WI (US); Darin Robert Okerlund, Muskego, WI (US)

Correspondence Address: GE Healthcare, IP Department, 20225 Water Tower Blvd., Mail Code W492, BROOKFIELD, WI, 53045, US

(73) Assignee: GENERAL ELECTRIC COMPANY, Schenectady, NY (US)

(21) Appl. No.: 12/478,433

(22) Filed: Jun. 4, 2009

(51) Int. Cl. H05G 1/60

(52) U.S. Cl. 378/5

(57) ABSTRACT

A method and apparatus of computed tomography includes accessing multiple-energy computed tomography data and decomposing the multiple-energy computed tomography data to generate a monochromatic image including an anatomical region. The method and apparatus also includes segmenting the anatomical region from the monochromatic image to create a segmented region and generating a composite image including the segmented region.

### FIELD OF THE INVENTION

This disclosure relates generally to a computed tomography method and apparatus for generating a composite image.

### BACKGROUND OF THE INVENTION

Typically, in computed tomography (CT) imaging systems, an x-ray source emits a fan-shaped or a cone-shaped x-ray beam toward an object, such as a patient or a piece of luggage, positioned on a support. The x-ray beam, after being attenuated by the object, impinges upon a detector. The intensity of the attenuated x-ray beam received at the detector is typically dependent upon the attenuation of the x-ray beam by the object.

In known third generation CT systems, the x-ray source and the detector are rotated on a gantry around the object to be imaged so that a gantry angle at which the fan-shaped x-ray beam intersects the object constantly changes. Data representing the intensity of the received x-ray beam at the detector is collected across a range of gantry angles. The data are ultimately processed to form an image.

The x-ray source of a conventional CT systems emits a polychromatic x-ray beam including x-ray photons at a variety of energy levels. The x-ray attenuation of each material in the object is dependent upon the energy level of the x-ray photon. Due to this relationship, images acquired with a polychromatic x-ray beam tend to suffer from beam hardening artifacts. It is often desirable to segment a specific anatomical region, such as an organ, from an image generated with data acquired with a polychromatic x-ray beam. However, since the spectrum in the polychromatic x-ray beam was not chosen specifically for the anatomical region and since the image reconstructed from polychromatic x-ray data may contain beam hardening artifacts, it is often difficult to obtain an accurate segmentation of certain anatomical regions. A more effective technique for segmenting specific anatomical regions from computed tomography data is needed.

### BRIEF DESCRIPTION OF THE INVENTION

The above-mentioned shortcomings, disadvantages and problems are addressed herein which will be understood by reading and understanding the following specification.

In an embodiment, a method of computed tomography includes accessing multiple-energy computed tomography data, identifying an anatomical region in the multiple-energy computed tomography data, and selecting an energy level. The method includes decomposing the multiple-energy computed tomography data to generate a monochromatic image at the energy level. The method includes segmenting the anatomical region from the image to create a segmented region, generating a composite image including the segmented region, and displaying the composite image.

In an embodiment, a method of computed tomography includes acquiring multiple-energy computed tomography data, identifying a first anatomical region in the multiple-energy computed tomography data, and selecting a first energy level. The method includes decomposing the multiple-energy computed tomography data to generate a first monochromatic image at the first energy level. The method includes segmenting the first anatomical region from the first monochromatic image to create a first segmented region. The method includes identifying a second anatomical region in the multiple-energy computed tomography data and selecting a second energy level. The method includes decomposing the multiple-energy computed tomography data to generate a second monochromatic image at the second energy level. The method includes segmenting the second anatomical region from the second monochromatic image to create a second segmented region. The method includes generating a composite image including the first segmented region and the second segmented region, and displaying the composite image.

In an embodiment, a workstation for analyzing computed tomography data includes a memory, a display, and a processor connected to the memory and the display. The processor is configured to access multiple-energy computed tomography data and decompose the multiple-energy computed tomography data to generate a monochromatic image. The processor is configured to segment an anatomical region from the monochromatic image to create a segmented region. The processor is also configured to generate a composite image including the segmented region.

Various other features, objects, and advantages of the invention will be made apparent to those skilled in the art from the accompanying drawings and detailed description thereof.

### BRIEF DESCRIPTION OF THE DRAWINGS

FIG. 1 is a schematic representation of a computed tomography system and a workstation in accordance with an embodiment; and

FIG. 2 is a flow-chart illustrating a method of computed tomography in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

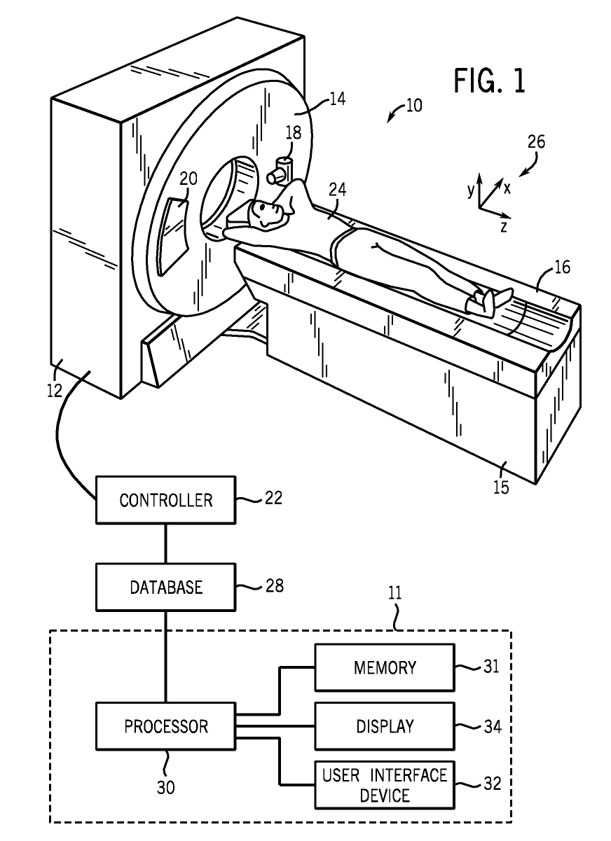

Referring to FIG. 1, a schematic representation of a computed tomography (CT) system 10 and a workstation 11 according to an embodiment is shown. The CT system 10 includes a gantry support 12, a gantry 14, a table support 15, a table 16, an x-ray generator (not shown), an x-ray source 18, a detector 20, and a controller 22. The gantry 14 is configured to rotate within the gantry support 12. The gantry 14 is adapted to retain the x-ray source 18 and the detector 20. According to an embodiment, the x-ray generator is configured to deliver inputs at more than one kilovolt peak (kVp). For example, the x-ray generator may be configured to deliver both a high-kVp input and a low-kVp input to the x-ray source 18. According to an embodiment, the high-kVp input may comprise a 140 kVp input while the low-kVp input may comprise an 80 kVp input. The x-ray source 18 receives either the high-kVp input or the low-kVp input from the generator and emits an x-ray beam. If the x-ray source 18 receives the high-kVp input, the x-ray beam will comprise a high-kVp x-ray beam. If the x-ray source 18 receives the low-kVp input, the x-ray beam will comprise a low-kVp x-ray beam. Both the high-kVp x-ray beam and the low-kVp x-ray beam are polychromatic, meaning that they include x-ray photons from a wide energy spectrum. One skilled in the art should appreciate that the term “low-kVp x-ray beam” indicates that the highest energy x-ray photons in the low-kVp x-ray beam are lower than the highest energy x-ray photons in the “high-kVp x-ray beam.” The terms “low-kVp x-ray beam” and “high-kVp x-ray beam” are not meant to indicate absolute kVp levels.

According to an embodiment, the x-ray source 18 is configured to emit either a high-kVp x-ray beam or a low-kVp x-ray beam through a patient 24 being examined. After passing through the patient 24, either the high-kVp x-ray beam or the low-kVp x-ray beam is received at the detector 20. The detector 20 comprises a plurality of detector elements (not shown). Each of the plurality of detector elements produces an electrical signal that varies based on the intensity of the x-ray beam received during a sampling interval. According to an embodiment, multiple-energy computed tomography (MECT) data may be acquired by collecting attenuation data with both the low-kVp x-ray beam and the high-kVp x-ray beam. For purposes of this disclosure, the term “MECT data” is defined to include computed tomography data acquired at more than two different kVps. For example, according to additional embodiments, the x-ray source 18 may be configured to emit x-ray beams at a low kVp, a medium kVp, and a high kVp. The table 16 is adapted to translate the patient 24 in a z-direction with respect to the gantry 14 as indicated by a coordinate axis 26. The controller 22 is configured to control the rotation of the gantry 14, the position of the table 16, and the activation of the x-ray source 18.

According to an embodiment, data acquired by the CT system 10 may be transmitted to a database 28. The workstation 11 may access data that is stored on the database 28. According to an embodiment, the workstation includes a processor 30, a memory 31, a user interface device 32, such as a keyboard and/or a mouse, and a display 34. The processor 30 is capable of manipulating the MECT data and may comprise one or more integrated circuits according to an embodiment. The memory 31 may comprise a RAM, a ROM, a flash card, a magnetic drive, a hard disk drive, a CD-ROM, an optical drive or the like. According to other embodiments, the workstation 11 may receive the computed tomography data directly from the CT system 10.

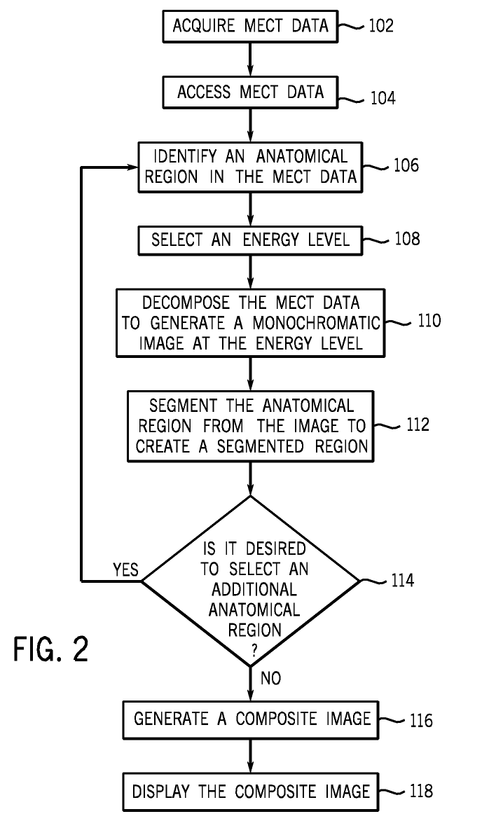

FIG. 2 is a flow chart illustrating a method 100 in accordance with an embodiment. The individual blocks 102-118 represent steps that may be performed in accordance with the method 100. The technical effect of the method 100 is the generation and display of a composite image from MECT data.

Referring to both FIG. 1 and FIG. 2, at step 102, the controller 22 controls the x-ray source 18, the gantry 14 and the table 16 to acquire MECT data. For example, the controller 22 may control the x-ray source 18 to alternate between emitting a low-kVp x-ray beam at 80 kVp and a high-kVp x-ray beam at 140 kVp. It should be appreciated by those skilled in that art that both the low-kVp x-ray beam and the high-kVp x-ray beam are polychromatic, meaning that they both include a plurality of different energy levels. A complete set of data may be acquired at both 80 kVp and at 140 kVp. Embodiments may acquire the 80 kVp data and the 140 kVp data in either a back-to-back or an interleaved manner. In other embodiments, the MECT data may include energies other than 140 kVp and 80 kVp. Other embodiments may not acquire a complete set of data at each kVp. Additionally, still other embodiments may acquire MECT data from three or more distinct kVps. The MECT data may be stored in the database 28.

At step 104, the workstation 11 accesses the MECT data that was acquired at step 102 from the database 28. The accessing of the MECT data may also include retrieving the MECT data from the CT system 10 according to another embodiment.

At step 106, an anatomical region is identified in the MECT data. According to an embodiment, the anatomical region may comprise an organ, a tissue, or a pathology. An operator may indicate the anatomical region by first generating an initial image from the MECT data and displaying the initial image on the display 34. The initial image may be a polychromatic image at either the high-kVp or the low-kVp, or the initial image may be at an energy level generated by applying a decomposition transformation to the MECT data. The decomposition transformation will described in more detail hereinafter. The operator may then identify the anatomical region in the initial image. According to an exemplary embodiment, the operator may deposit a region of interest within the anatomical region. According to another embodiment, the operator may select the anatomical region by clicking on a region of the image with the user interface device 32.

Still referring to step 106, the processor 30 may identify an anatomical region based on an energy curve. Every material has a unique energy curve. For the purposes of this disclosure, the term “energy curve” includes a curve representing how a material attenuates x-rays at different x-ray energy levels. Assuming that there is enough of a separation between the high-kVp and the low-kVp, the processor 30 should be able to identify the materials in the MECT data with a high degree of confidence. For example, an image may be generated from the MECT data. The processor 30 then attempts to identify a portion of the image that has an energy curve that is close to that of a desired material, such as liver tissue, for example. It should be appreciated that the term image includes both a two-dimensional image and a three-dimensional image. Also, for purposes of this disclosure, the term image does not refer exclusively to images that are displayed. For example, after the MECT data has been reconstructed on the processor 30, the result is considered to be an image even though it may or may not be displayed on the display 34. Once the anatomical region has been identified, the processor 30 may continue to identify additional anatomical regions in the image, or the method 100 may proceed to step 108.

At step 108, an energy level is selected. The energy level may be selected by a variety of techniques. According to an embodiment, the operator may specify the energy level. For example, the operator may desire to see a monochromatic image of the anatomical region at a specific energy level, such as 120 Kev. According to another embodiment, the processor 30 may automatically assign a default energy level based on the material in the anatomical region. For example, if the anatomical region is a kidney, the processor 30 may select the energy level that has yielded the best results during previous kidney studies. According to another embodiment, the processor 30 may select an energy level that optimizes a parameter such as a contrast level or a contrast-to-noise ratio in the anatomical region.

At step 110, the MECT data is decomposed to generate a monochromatic image at the energy level that was selected during step 108. The high-kVp data and the low-kVp data may be decomposed through a variety of decomposition methods, such as a CT number difference decomposition, a Compton and photoelectric decomposition, a basis material decomposition (BMD), or a logarithm subtraction decomposition.

According to an exemplary embodiment, a BMD transformation is used to generate a monochromatic image at a specific energy level. Since the MECT data includes attenuation data at two or more different attenuation levels, by implementing the BMD transformation, it is possible to decompose the attenuation characteristic of each voxel, or volume element, in the image into a linear combination of two or more basis materials such as water and iodine. According to an embodiment, the linear combination of two basis materials may be used to generate one or more monochromatic images. It should be appreciated by those skilled in the art that the BMD transformation may be applied to MECT data in either the projection space or in the image domain.

According to an exemplary embodiment, a BMD transformation may be implemented to decompose the MECT data and generate a monochromatic image from the MECT data. The monochromatic image generated through the BMD transformation is different from a convention CT image even though both may be represented in Hounsfield numbers. For example, the conventional CT image shows attenuation values that were acquired with a polychromatic x-ray beam, while the monochromatic image represents attenuation values as if they were acquired with a monochromatic x-ray beam. As an example, the MECT data may have been acquired at 80 kVp and 140 kVp. However, through a BMD transformation, a monochromatic image at, for example, 90 Kev may be generated. The monochromatic images remove beam hardening effects and provide a way for users to more clearly see the attenuation characteristics of each material in the scanned object. The details of the BMD transformation are well-known by those skilled in the art.

At step 112, the anatomical region that was identified during step 106 may be segmented from the image. Since the energy level selected during step 108 was selected specifically for the anatomical region, it should be possible to obtain a more accurate segmentation of the anatomical region. For example, if either the contrast is higher than a conventional polychromatic image and/or the noise is lower, the segmentation algorithm may be able to more accurately determine which portions of the image are part of the anatomical region and which portions are not part of the anatomical region. According to an embodiment, the segmentation algorithm may comprise using both a threshold based on CT number and a connected component analysis to determine if a particular voxel belongs in the segmented region. Those skilled in the art should appreciate that a wide variety of additional segmentation algorithms may be used during step 112.

At step 114, the processor 30 determines if it is desired to select an additional anatomical region. If it is desired to select an additional anatomical region, then the method 100 returns to step 106 where a second anatomical region is identified. The method 100 then proceeds through steps 108-114 in a manner similar to that which was previously described. It should be appreciated that the method 100 may cycle through steps 106-114 one or more times depending upon the embodiment.

If at step 114, the processor 30 determines that it is not desired to select any additional anatomical regions, then the method 100 proceeds to step 116. At step 116 a composite image is generated. According to an embodiment where the method cycles through steps 106-112 only one time, the composite image may comprise the segmented region from step 112 and a base image. According to an exemplary embodiment, the base image is a monochromatic image at an energy level other than the one selected at step 108. For example, the energy level of the base image may be selected to optimize a contrast-to-noise ratio for all parts of the image other than the segmented region. The composite image may include the segmented region at the energy level selected during step 108 and the base image at a different energy level. By representing the segmented region and the base image at separate energy levels, it may be possible to generate a composite image with better image quality than an image that was generated at only a single energy level. According another embodiments, the base image may be a different type of image generated by decomposing the MECT data, such as an atomic number image that assigns a grey-scale value to each voxel based on an effective atomic number of the material. The base image may also comprise a polychromatic image according to yet another embodiment.

According to a second exemplary embodiment, the method 100 cycles through steps 106-114 two times, generating a first segmented region at a first energy level and a second segmented region at a second energy level. At step 116, the processor 30 generates a composite image. The composite image comprises the first segmented region at the first energy level and the second segmented region at the second energy level. The first segmented region and the second segmented region may be pasted into a base image. Still other embodiments may result in the generation of more than two segmented regions. It should also be appreciated that all of the segmented regions may have a unique energy level or that two or more of the segmented regions may share a common energy level. According to an embodiment, the energy level for each of the segmented regions is selected to optimize an image parameter, such as the contrast level or the contrast-to-noise ratio.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method of computed tomography comprising:
accessing multiple-energy computed tomography data;
identifying an anatomical region in the multiple-energy computed tomography data;
selecting an energy level;
decomposing the multiple-energy computed tomography data to generate a monochromatic image at the energy level, said monochromatic image including the anatomical region;
segmenting the anatomical region from the image to create a segmented region;
generating a composite image, said composite image comprising the segmented region; and
displaying the composite image.

2. The method of claim 1, wherein the composite image further comprises a base image at a different energy level than the segmented region.

3. The method of claim 1, wherein said identifying the anatomical region comprises identifying the anatomical region based on an energy curve.

4. The method of claim 1, wherein said identifying the anatomical region comprises generating an initial image from the multiple-energy computed tomography data and positioning a region-of-interest in the initial image.

5. The method of claim 1, wherein said selecting the energy level comprises manually selecting the energy level.

6. The method of claim 1, wherein said selecting the energy level comprises selecting the energy level based on the anatomical region.

7. The method of claim 1, wherein said selecting the energy level comprises selecting the energy level to optimize a parameter within the anatomical region.

8. The method of claim 7, wherein the parameter comprises a contrast level or a contrast-to-noise ratio.

9. The method of claim 1, wherein the anatomical region comprises a tissue, an organ, or a pathology.

10. The method of claim 1, wherein said decomposing the multiple-energy computed tomography data comprises applying a basis material decomposition transformation to the multiple-energy computed tomography data.

11. The method of claim 1, wherein said identifying the anatomical region comprises identifying a first anatomical region and a second anatomical region.

12. The method of claim 11, wherein said selecting the energy level comprises selecting a first energy level and a second energy level.

13. The method of claim 12, wherein said decomposing the multiple-energy computed tomography data comprises decomposing the multiple-energy computed tomography data to generate a first monochromatic image at the first energy level and a second monochromatic image at the second energy level.

14. The method of claim 13, wherein said segmenting the anatomical region comprises segmenting the first anatomical region from the first monochromatic image to create a first segmented region and segmenting the second anatomical region from the second monochromatic image to create a second segmented region.

15. The method of claim 14, wherein said generating the composite image comprises generating the composite image comprising the first segmented region and the second segmented region.

16. A method of computed tomography comprising:
acquiring multiple-energy computed tomography data;
identifying a first anatomical region in the multiple-energy computed tomography data;
selecting a first energy level;
decomposing the multiple-energy computed tomography data to generate a first monochromatic image at the first energy level, said first monochromatic image including the first anatomical region;
segmenting the first anatomical region from the first monochromatic image to create a first segmented region;
identifying a second anatomical region in the multiple-energy computed tomography data;
selecting a second energy level;
decomposing the multiple-energy computed tomography data to generate a second monochromatic image at the second energy level, said second monochromatic image including the second anatomical region;
segmenting the second anatomical region from the second monochromatic image to create a second segmented region;
generating a composite image, said composite image comprising the first segmented region and the second segmented region; and
displaying the composite image.

17. A workstation for analyzing computed tomography data comprising:
a memory;
a display; and
a processor connected to the memory and the display, wherein said processor is configured to:
access multiple-energy computed tomography data;
decompose the multiple-energy computed tomography data to generate a monochromatic image;
segment an anatomical region from the monochromatic image to create a segmented region; and
generate a composite image comprising the segmented region.

18. The workstation of claim 17, wherein the processor is further configured to display the composite image on the display.

19. The workstation of claim 17, wherein the processor is configured to decompose the multiple-energy computed tomography data by applying a basis material decomposition transformation.

20. The workstation of claim 17, wherein the composite image further comprises a base image.
